(19) United States
(12) Patent Application Publication
(10) Pub. No.: US 2022/0215820 A1
(43) Pub. Date: Jul. 7, 2022

(54) AUDIO SIGNAL ANALYSIS METHOD, AUDIO SIGNAL ANALYSIS SYSTEM AND NON-TRANSITORY COMPUTER-READABLE MEDIUM

(71) Applicant: Yamaha Corporation, Hamamatsu (JP)

(72) Inventors: Shoken KANEKO, Hamamatsu (JP); Ikumi OSAKI, Hamamatsu (JP)

(21) Appl. No.: 17/705,038

(22) Filed: Mar. 25, 2022

Related U.S. Application Data
(63) Continuation of application No. PCT/JP2020/034646, filed on Sep. 14, 2020.

(30) Foreign Application Priority Data
Sep. 27, 2019 (JP) 2019-176821

(51) Int. Cl. G10H 1/06; G10H 1/00

(52) U.S. Cl. CPC G10H 1/06; G10H 1/0008; G10H 2250/005; G10H 2210/331; G10H 2210/066

(57) ABSTRACT

An audio signal analysis system comprises an electronic controller that is configured to execute a plurality of modules including an acquisition module configured to acquire a first spectrum, which is a time average of a plurality of frequency spectra of an audio signal, a specification module configured to acquire a plurality of reference values corresponding to different pitches that follow a prescribed temperament and configured to specify, by a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and a correction module configured to correct the frequency difference so as to reduce systematic error included in the frequency difference specified by the specification module.

### CROSS-REFERENCE TO RELATED APPLICATIONS

This application is a continuation application of International Application No. PCT/JP2020/034646, filed on Sep. 14, 2020, which claims priority to Japanese Patent Application No. 2019-176821 filed in Japan on Sep. 27, 2019. The entire disclosures of International Application No. PCT/JP2020/034646 and Japanese Patent Application No. 2019-176821 are hereby incorporated herein by reference.

### BACKGROUND

### Field of the Invention

The present invention generally relates to a technology for analyzing audio signals.

### Background Information

Various techniques for analyzing audio signals have been proposed in the prior art. For example, an acoustic analysis library “Librosa” (https://librosa.github.io/librosa/index.html), searched on Jun. 26, 2019, (Non-Patent Document 1) discloses a technology for specifying a frequency difference that indicates how much the frequency of a sound represented by an audio signal deviates from a reference value (amount of deviation using 440 Hz of a tempered scale as the reference value).

### SUMMARY

However, the technology of Non-Patent Document 1 has the problem that a large number of calculations are required to specify the frequency difference, and that the specified frequency difference has a large error variance. Given the circumstances described above, an object of the present disclosure is to specify the frequency difference of an audio signal robustly and with high accuracy while reducing the number of calculations.

In view of the state of the known technology, an audio signal analysis method according to one aspect of the present disclosure comprises acquiring a first spectrum, which is a time average of a plurality of frequency spectra of an audio signal, acquiring a plurality of reference values corresponding to different pitches that follow a prescribed temperament, specifying, by a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and correcting the frequency difference so as to reduce systematic error included in the frequency difference specified by the problem-solving search algorithm.

In view of the state of the known technology, an audio signal analysis system according to another aspect of the present disclosure comprises an electronic controller including at least one processor. The electronic controller is configured to execute a plurality of modules including an acquisition module configured to acquire a first spectrum, which is a time average of a plurality of frequency spectra of an audio signal, a specification module configured to acquire a plurality of reference values corresponding to different pitches that follow a prescribed temperament and configured to specify, by a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and a correction module configured to correct the frequency difference so as to reduce systematic error included in the frequency difference specified by the specification module.

### BRIEF DESCRIPTION OF THE DRAWINGS

FIG. 1 is a block diagram showing the configuration of an audio signal analysis system according to a first embodiment of the present disclosure.

FIG. 2 is a block diagram showing the functional configuration of a control device.

FIG. 3 is a schematic diagram of a first spectrum.

FIG. 4 is a schematic diagram of a provisional spectrum.

FIG. 5 is a flowchart of a process that is executed by the control device.

FIG. 6 is a flowchart of a process for specifying an analysis frequency difference.

FIG. 7 is an explanatory diagram relating to a search for the analysis frequency difference.

FIG. 8 is a graph relating to an error of the analysis frequency difference before correction.

FIG. 9 is a graph relating to an error of the analysis frequency difference after correction.

FIG. 10 is a table representing the result of observing the error of the analysis frequency difference after correction according to the first embodiment and a comparative example.

FIG. 11 is a block diagram illustrating a functional configuration of a control device according to a second embodiment.

FIG. 12 is a table representing the result of observing the error of the analysis frequency difference in a third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### A: First Embodiment

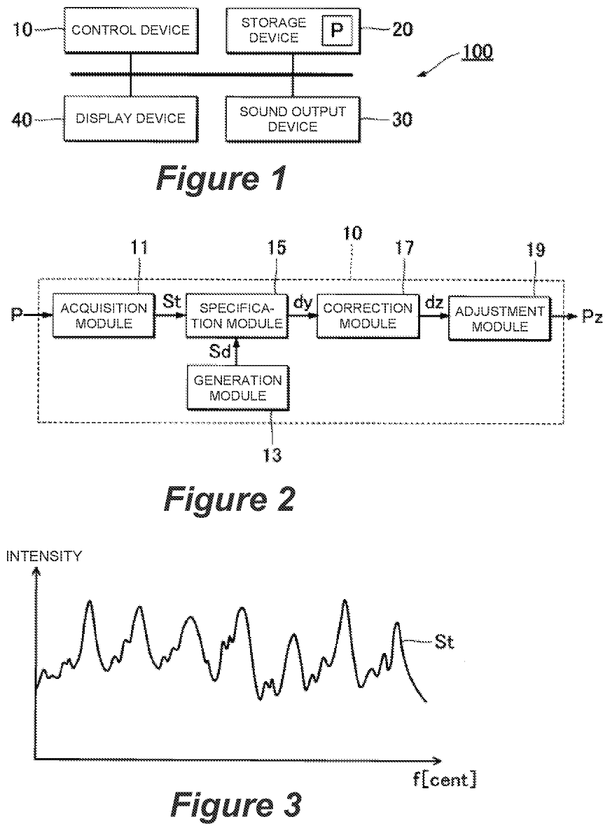

FIG. 1 is a block diagram illustrating the configuration of an audio signal analysis system 100 according to a first embodiment of the present disclosure. The audio signal analysis system 100 is a computer system that analyzes an audio signal P. The audio signal P is a time domain signal representing various sounds, such as the sound of an instrument that is produced by the performance of a musical piece, a singing sound generated by the singing of a musical piece, and the like. The audio signal analysis system 100 is a portable information terminal such as a mobile phone or a smartphone, or a portable or stationary information terminal such as a personal computer. The user of the audio signal analysis system 100 is, for example, a performer that plays a musical instrument in accordance with the reproduction of the sound represented by the audio signal P. The audio signal analysis system 100 comprises a control device 10, a storage device 20, a sound output device 30, and a display device or display 40. The audio signal analysis system 100 can be realized as a single device, or as a plurality of devices which are separately configured.

The control device 10 is, for example, an electronic controller including one or a plurality of processors that control each element of the audio signal analysis system 100. The control device 10 is composed of one or more types of processors, such as a CPU (Central Processing Unit), a GPU (Graphics Processing Unit), a DSP (Digital Signal Processor), an FPGA (Field Programmable Gate Array), an ASIC (Application Specific Integrated Circuit), and the like. Here, the term “electronic controller” as used herein refers to hardware, and does not include a human.

The storage device 20 is one or a plurality of computer memories or memory units, each composed of a known storage medium such as a magnetic storage medium or a semiconductor storage medium. A program that is executed by the control device 10 and various data that are used by the control device 10 are stored in the storage device 20. The storage device 20 can be composed of a combination of a plurality of types of storage media. A portable storage medium (for example, an optical disc) that can be attached to/detached from the audio signal analysis system 100 or an external storage medium (for example, online storage) with which the audio signal analysis system 100 can communicate via a communication network can also be used as the storage device 20. Thus, the storage device 20 can be any computer storage device or any computer readable medium with the sole exception of a transitory, propagating signal. For example, the storage device 20 can be a computer memory which can be nonvolatile memory and volatile memory. The storage device 20 stores an audio signal P that represents the sounds of a musical piece (for example, instrument sounds or singing sounds). Each frequency of the sound represented by the audio signal P may not match a prescribed reference value due to musical expression or an unintended error. For example, the frequency of the sound of “A (la)” represented by the audio signal P can be different from the reference value of 440 Hz. The sound represented by the audio signal P is not limited to the sound of an instrument being played or the sound of a musical piece being sung.

The display device 40 (for example, a liquid-crystal display panel) displays various images under the control of the control device 10. The sound output device 30 (for example, a speaker) is a playback device that emits the sound represented by the audio signal P.

FIG. 2 is a block diagram showing the functional configuration of the control device 10. The control device 10 realizes a plurality of functions (an acquisition module 11, a generation module 13, a specification module 15, a correction module 17, and an adjustment module 19) for analyzing the audio signal P by the execution of a plurality of tasks in accordance with a program that is stored in the storage device 20. In other words, the program is stored a non-transitory computer-readable medium, such as the storage device 20, and causes the control device 10 to execute an audio signal analysis method or function as the acquisition module 11, the generation module 13, the specification module 15, the correction module 17, and the adjustment module 19. Some or all of the functions of the control device 10 can be realized by a dedicated electronic circuit.

The acquisition module 11 acquires a first spectrum St from the audio signal P. FIG. 3 is a schematic diagram of the first spectrum St. The first spectrum St is represented by a series of a plurality of numerical values that correspond to different frequencies (frequency bins) on the frequency axis. The acquisition module 11 generates the first spectrum St from the audio signal P by means of a known frequency analysis, such as a Fast Fourier Transform. Specifically, the first spectrum St is an average spectrum obtained by averaging a plurality of frequency spectra of the audio signal P within a prescribed time interval (hereinafter referred to as “analysis interval”) on the time axis. That is, the first spectrum St is a time average of a plurality of frequency spectra of the audio signal P. The analysis interval in the first embodiment is the entire section of the audio signal P (that is, the entire musical piece). The acquisition module 11 calculates the frequency spectrum for each of a plurality of frames included in the analysis interval and averages the plurality of frequency spectra corresponding to the different frames, thereby generating the first spectrum St. The acquisition module 11 can acquire the first spectrum St stored in advance in the storage device 20.

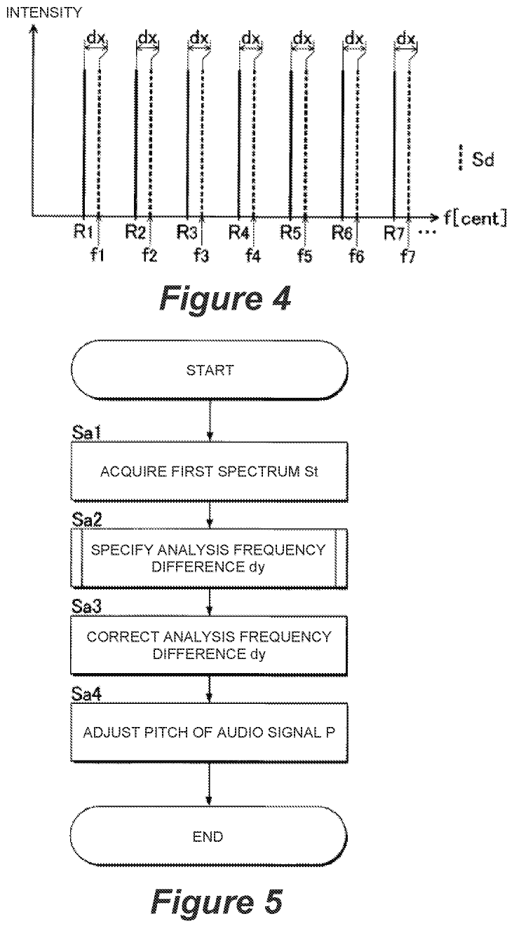

The generation module 13 of FIG. 2 generates a provisional spectrum Sd. In FIG. 4, the provisional spectrum Sd is schematically indicated by the broken lines. The provisional spectrum Sd includes components corresponding to each of N different frequencies fn (n=1 to N). The N frequencies fn are discrete values set on the frequency axis at intervals in accordance with equal temperament. Specifically, the interval between two frequencies fn adjacent to each other on the frequency axis is 100 cent. That is, the N frequencies fn have a one-to-one correspondence with a plurality of pitches in a scale that follows equal temperament. Each frequency fn is a frequency that deviates from a reference frequency (hereinafter referred to as “reference value”) Rn by a prescribed frequency difference dx. That is, the frequency difference dx is the amount of deviation from the reference value Rn on the frequency axis.

N reference values Rn are known values stored in the storage device 20. The generation module 13 acquires N reference values Rn from the storage device 20. The N reference values Rn are defined on the frequency axis in accordance with equal temperament, in the same manner as the N frequencies fn. That is, the interval between two reference values Rn adjacent to each other on the frequency axis is 100 cent. The frequency difference dx is common over the N frequencies fn. One frequency (for example, 440 Hz), and frequencies that have a relationship with said frequency defined by equal temperament can be regarded as a plurality of reference values Rn. That is, each reference value Rn is a frequency corresponding to the pitch of a constituent sound in a scale that follows equal temperament. As can be understood from the foregoing explanation, the provisional spectrum Sd is a spectrum that includes N components, each having the frequency difference dx with respect to the N reference values Rn corresponding to pitches of equal temperament (an example of prescribed temperament).

The specification module 15 of FIG. 2 specifies a frequency difference dx corresponding to a provisional spectrum Sd (hereinafter referred to as “second spectrum”) that is similar to the first spectrum St (hereinafter referred to as “analysis frequency difference dy”). Specifically, the frequency difference dx of the provisional spectrum Sd (second spectrum), whose distance M from the first spectrum St is less than a prescribed threshold value, is specified as the analysis frequency difference dy. The distance M is an index representing the degree of similarity or difference between the first spectrum St and the provisional spectrum Sd. Specifically, the distance M is calculated, for example, by appending a negative sign to the inner product of the vector representing the first spectrum St and the vector representing the provisional spectrum Sd. For example, the Euclidean distance can be used as the distance M. Therefore, the distance M decreases as the degree of similarity between the first spectrum St and the provisional spectrum Sd increases. The second spectrum is the provisional spectrum Sd that includes frequency components fn that deviate from the reference value Rn by the analysis frequency difference dy.

Specifically, the specification module 15 specifies the analysis frequency difference by means of a problem-solving search algorithm. The problem-solving search algorithm is a search algorithm for specifying an analysis frequency difference dy by dividing the numerical range that said analysis frequency difference dy can take on (hereinafter referred to as “search interval H”) into a plurality of unit areas h. Specifically, the problem-solving search algorithm of the first embodiment is a golden-section search. In other words, the provisional spectrum Sd is a candidate for the second spectrum. As can be understood from the foregoing explanation, the second spectrum is a spectrum that is similar to the first spectrum St. That is, the analysis frequency difference dy represents how much the pitch (frequency fn) of each of the sounds that constitute an equal temperament scale in the first spectrum St deviates from the reference value Rn.

Here, it is assumed that the analysis frequency difference dy specified by the specification module 15 is the actual value of the frequency difference of the sound represented by the audio signal P (amount of deviation with respect to a reference value Rn). However, it was empirically confirmed by the inventors of the present disclosure that systematic errors occur in the analysis frequency difference dy that is specified by means of the problem-solving search algorithm, with respect to the actual value of the frequency difference of the sound represented by the audio signal P. A systematic error is an error that is systematically measured with respect to the actual value. Specifically, it was found that the analysis frequency difference dy tends to be greater than the actual frequency difference by about 0.7-1.0 cent. Thus, the correction module 17 of FIG. 2 corrects the analysis frequency difference dy so as to reduce the systematic error included in the analysis frequency difference dy. Specifically, the correction module 17 subtracts a prescribed correction value from the analysis frequency difference dy, thereby calculating an analysis frequency difference dz. The prescribed correction value is a value set in advance in accordance with the systematic error, and is, for example, 0.7-1.0 cent.

The adjustment module 19 adjusts the pitch of the audio signal P in accordance with the analysis frequency difference dz after correction by the correction module 17. Specifically, the adjustment module 19 shifts the pitch of the audio signal P by the analysis frequency difference dz, thereby generating an audio signal Pz. The sound output device 30 outputs sound corresponding to the audio signal Pz. That is, sound in which the pitch of the audio signal P is closer to the reference value Rn is output.

FIG. 5 is a flowchart of the process that is executed by the control device 10. The process of FIG. 5 is initiated, for example, in response to an instruction from a user. When the process of FIG. 5 is initiated, the acquisition module 11 acquires the first spectrum St from the analysis interval of the audio signal P (Sa1). The control device 10 acquires N reference values Rn from the storage device 20 and then specifies the analysis frequency difference dy corresponding to the first spectrum St (Sa2).

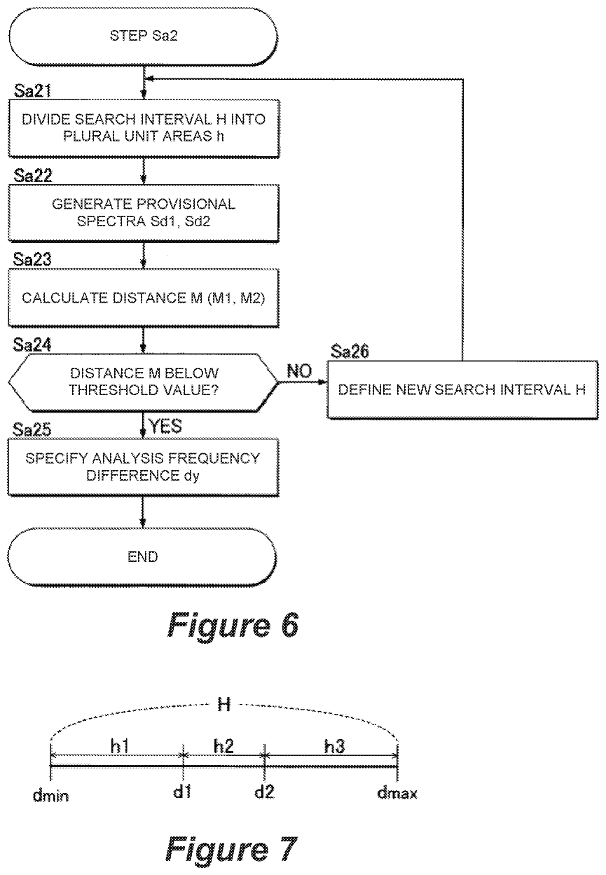

FIG. 6 is a detailed flowchart of the process (Sa2) for specifying the analysis frequency difference dy. FIG. 7 is an explanatory diagram relating to a search for the analysis frequency difference dy. FIG. 7 shows the search interval H of the analysis frequency difference dy. The search interval H is the numerical range between a minimum value dmin and a maximum value dmax. The initial search interval H immediately after starting the search for the analysis frequency difference dy is set to a prescribed numerical range that includes the numerical values that the analysis frequency difference dy can take on.

The generation module 13 divides the search interval H into K unit areas hk (k=1-K) (Sa21). Specifically, the specification module 15 divides the search interval H into three unit areas hk (h1-h3) using boundary values d1 and d2. That is, the unit area h1 is the range between the minimum value dmin and the boundary value d1. The unit area h2 is the range between the boundary value d1 and the boundary value d2. The unit area h3 is the range between the boundary value d2 and the maximum value dmax. In the golden-section search, “interval of unit area h1: (interval of unit area h2+interval of unit area h3)” and “interval of unit area h2: interval of unit area h3” are respectively set to be a prescribed golden ratio “1:(1+5^{1/2})/2”.

The generation module 13 generates the provisional spectrum Sd (Sa22). Specifically, a provisional spectra Sd is generated, in which both the boundary value d1 and the boundary value d2 are the frequency difference dx. That is, a provisional spectrum Sd1, which deviates from the reference value Rn by the boundary value d1, and a provisional spectrum Sd2, which deviates from the reference value Rn by the boundary value d2, are generated.

The specification module 15 calculates a distance M1 between the provisional spectrum Sd1 and the first spectrum St, and a distance M2 between the provisional spectrum Sd2 and the first spectrum St (Sa23). The specification module 15 then determines whether the distance M1 and the distance M2 each falls below a prescribed threshold value (Sa24). If it is determined that the distance M1 and/or the distance M2 falls below the threshold value (Sa24: YES), the specification module 15 specifies, as the analysis frequency difference dy, the frequency difference dx of the provisional spectrum Sd (Sd1 or Sd2) corresponding to the distance M (M1 or M2) that falls below the threshold value (Sa25). If both the distance M1 and the distance M2 fall below the threshold value, the frequency difference dx of the provisional spectrum Sd corresponding to the distance M, which is the smaller of the distance M1 and the distance M2, is specified as the analysis frequency difference dy.

If it is determined that both the distance M1 and the distance M2 exceed the threshold value (Sa24: NO), the specification module 15 uses the distance M1 and the distance M2 to set a new search interval H (Sa26). That is, the search interval H is updated in accordance with the distance M1 and the distance M2. Specifically, the specification module 15 excludes either the unit area h1 or the unit area h2 from the search interval H in accordance with the result of comparing the distance M1 and the distance M2. That is, the search interval H is narrowed, thereby setting a new search interval H. For example, if the distance M1 is greater than the distance M2, the specification module 15 excludes the unit area h1 from the search interval H, and sets the range between the boundary value d1 and the maximum value dmax as the new search interval H. That is, the boundary value d1 becomes the minimum value dmin in the new search interval H. On the other hand, if the distance M2 is greater than the distance M1, the specification module 15 excludes the unit area h3 from the search interval H and sets the range between the minimum value dmin and the boundary value d2 as the new search interval H. That is, the boundary value d2 becomes the maximum value dmax in the new search interval H.

When the new search interval H is set, the processes of Step Sa21-Step Sa24 are repeated. That is, the search interval H is narrowed in a stepwise manner, thereby specifying the frequency difference dx (that is, the analysis frequency difference dy) in which the distance M falls below the prescribed threshold value in the search interval H. The processes of Step Sa21-Step Sa24 can be repeatedly executed, thereby specifying the frequency difference dx that minimizes the distance M as the analysis frequency difference dy. In addition, if both the distance M1 and the distance M2 fall below the threshold value, the frequency difference dx between the frequency difference dx corresponding to the distance M1 and the frequency difference dx corresponding to the distance M2 can be specified as the analysis frequency difference dy.

As can be understood from the foregoing explanation, in the problem-solving search algorithm, the distance M is calculated with respect to the frequency differences dx that are the boundaries of the K unit areas hk, thereby specifying the analysis frequency difference dy. That is, it is possible to specify the optimal analysis frequency difference dy without calculating the distance M for each of all of the frequency differences dx within the search interval H.

When the analysis frequency difference dy is specified, as shown in FIG. 5, the correction module 17 corrects the analysis frequency difference dy so as to reduce the systematic error included in the analysis frequency difference dy, thereby calculating the analysis frequency difference dz (Sa3). The adjustment module 19 then adjusts the pitch of the audio signal P in accordance with the analysis frequency difference dz, thereby generating the audio signal Pz (Sa4). The audio signal Pz is output to the sound output device 30. The sound output device 30 outputs sound corresponding to the audio signal Pz.

As can be understood from the foregoing explanation, in the first embodiment, the analysis frequency difference dy corresponding to the second spectrum in which the distance M from the first spectrum St falls below the prescribed threshold value is specified by means of the problem-solving search algorithm, and the analysis frequency difference dy is corrected so as to reduce systematic error. Therefore, it is possible to specify the analysis frequency difference dz robustly and with high accuracy while reducing the number of calculations. The effects of the first embodiment will be described in detail below.

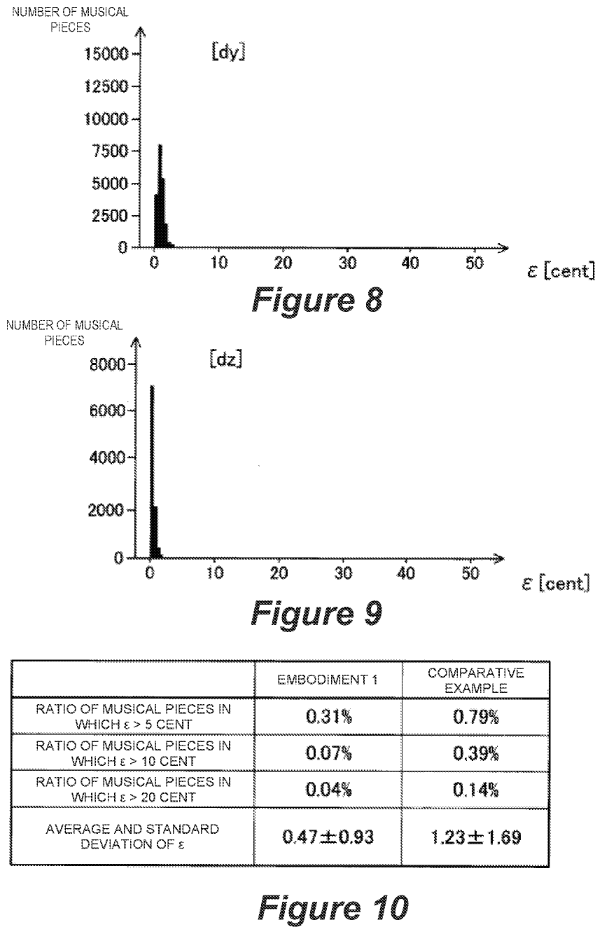

FIGS. 8 and 9 are graphs showing the relationships between the error (absolute value) E of the analysis frequency difference specified for each of the audio signals of a plurality of musical pieces (10,023 musical pieces), and the number of musical pieces that generated said error E. FIG. 8 is a graph relating to the error ε of the analysis frequency difference dy before correction, and FIG. 9 is a graph relating to the error ε of the analysis frequency difference dz after correcting for systematic error. As can be ascertained from FIGS. 8 and 9, among the plurality of musical pieces, the number of musical pieces in which the error ε of the analysis frequency difference dz after correcting for systematic error becomes 0 cent is greater than the number of musical pieces in which the error ε of the analysis frequency difference dy is 0 cent. That is, the error ε of the analysis frequency difference dz is smaller than the error ε of the analysis frequency difference dy. As can be understood from the foregoing explanation, the analysis frequency difference dy is corrected by the correction module 17, thereby specifying the analysis frequency difference dz in which the systematic error of the analysis frequency difference dy is reduced. Moreover, as can be ascertained by FIGS. 8 and 9, the variance of the error ε of the analysis frequency difference dz that occurs in a plurality of musical pieces is smaller than the variance of the error ε of the analysis frequency difference dy generated in a plurality of musical pieces. As can be understood from the foregoing explanation, by means of the first embodiment, it is possible to robustly specify the frequency difference of the audio signal P corresponding to the reference value Rn.

FIG. 10 is a table representing the result of observing the error ε of the analysis frequency difference for the first embodiment and a comparative example. FIG. 10 shows the result of analyzing the analysis frequency difference for each of 10,023 musical pieces. The comparative example is configured to use, for example, an audio analysis library (Librosa) (refer to https://librosa.github.io/librosa/generated/librosa.core.estimate_tuning.html?highlight=estimate % 20tuning#librosa.core.estimate_tuning) to specify the analysis frequency difference, and then to correct the analysis frequency difference. Specifically, the comparative example is configured to specify, as the analysis frequency difference, the most appropriate candidate value from among a plurality of grids (candidate values that are candidates for the analysis frequency difference dy) defined by a prescribed frequency resolution in a numerical range that the analysis frequency difference can take on, and then to correct said analysis frequency difference.

FIG. 10 shows the ratio of the total number of musical pieces in which the error c exceeds 5 cent, the ratio of the total number of musical pieces in which the error ε exceeds 10 cent, and the ratio of the total number of musical pieces in which the error ε exceeds 20 cent. FIG. 10 also shows the mean and standard deviation of the error ε.

As shown in FIG. 10, in the configuration of the first embodiment, the ratio of the musical pieces in which the error ε of the analysis frequency difference dz occurs is reduced as compared with the comparative example. In addition, in the configuration of the first embodiment, the mean and the standard deviation of the error ε are smaller as compared with the comparative example. As can be understood from the foregoing explanation, by means of the first embodiment, it is possible to specify the analysis frequency difference dz robustly and with high accuracy as compared with the comparative example. In the configuration of the comparative example, in order to specify the analysis frequency difference with high accuracy it is necessary to reduce the grid spacing as defined by the frequency resolution. When the grid spacing is reduced the number of calculations for specifying the analysis frequency difference increases. In contrast, by means of the configuration of the first embodiment, frequency difference candidates for the analysis frequency difference dz can be defined without being restricted by the frequency resolution, so that it is possible to specify the analysis frequency difference dz with high accuracy while reducing the number of calculations.

### B: Second Embodiment

A second embodiment of the present disclosure will now be described. In each of the embodiments illustrated below, elements that have the same functions as those in the first embodiment have been assigned the same reference symbols used to describe the first embodiment and detailed descriptions thereof have been appropriately omitted.

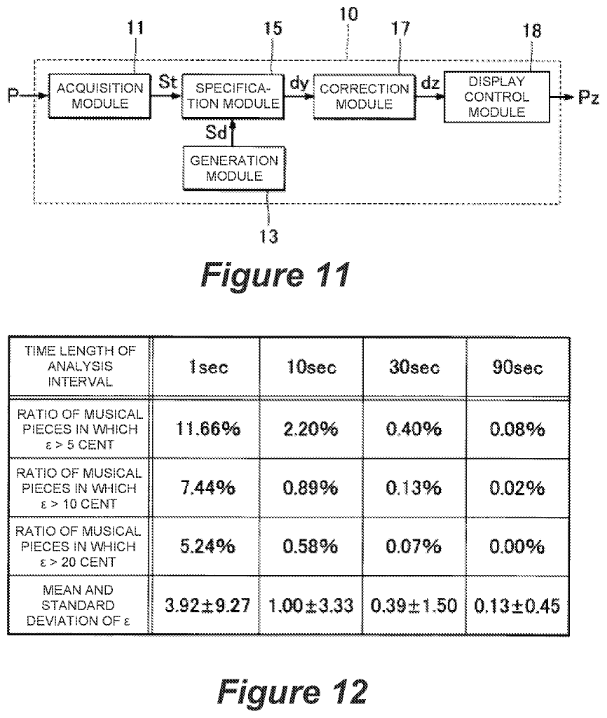

In the second embodiment, the analysis frequency difference dz is displayed. FIG. 11 is a block diagram illustrating the functional configuration of a control device 10 according to the second embodiment. As shown in FIG. 11, in the second embodiment, the adjustment module 19 of the first embodiment is replaced with a display control module 18. The display control module 18 outputs the analysis frequency difference dz generated by the correction module 17 to a display device 40. The display device 40 displays the analysis frequency difference dz output from the display control module 18. That is, the analysis frequency difference dz is displayed under the control of the display control module 18.

The same effects as those of the first embodiment are realized in the second embodiment. In the second embodiment, since the analysis frequency difference dz is displayed by the display device 40, a user can check the analysis frequency difference dz and tune a musical instrument in accordance with said analysis frequency difference dz. The user plays the musical instrument after tuning in parallel with the reproduction of the audio signal P. The user can play the musical instrument without perceiving a difference in pitch between the sound represented by the audio signal P and the performance sound of the musical instrument that the user plays. A configuration that has both the adjustment module 19 of the first embodiment and the display control module 18 of the second embodiment is also conceivable. That is, both the adjustment of the audio signal P in accordance with the analysis frequency difference dz and the display of said analysis frequency difference dz can be carried out.

### C: Third Embodiment

As described above, the acquisition module 11 calculates the first spectrum St by averaging the frequency spectra of the audio signal P within the analysis interval. In the first embodiment, a case was illustrated in which the analysis interval is the entire audio signal P. The analysis interval of a third embodiment is a part of the time interval of the audio signal P. The analysis interval is set to a prescribed time length that is shorter than the time length of a generic musical piece. The acquisition module 11 generates the first spectrum St by, for example, arbitrarily setting the position of the analysis interval in the audio signal P on the time axis and averaging the frequency spectra calculated for each frame within the analysis interval. The amount of processing for generating the first spectrum St decreases as the time length of the analysis interval decreases.

FIG. 12 is a table representing the results of observation of the error ε of the analysis frequency difference dz for each of a plurality of cases in which the time length of the analysis interval differs. FIG. 12 shows the results of observation of the error ε for each of a plurality of cases in which the time length of the analysis interval differs (1 second, 10 seconds, 30 seconds, and 90 seconds). It can be understood from FIG. 12 that the longer the time length of the analysis interval, the more accurately the analysis frequency difference dz can be estimated. On the other hand, it can also be understood from FIG. 12 that the analysis frequency difference dz can be estimated with sufficiently high accuracy even when the analysis interval is a short time interval, such as 30 seconds or 10 seconds. Although the analysis frequency difference dz can be estimated with adequate accuracy even when the analysis interval is about one second, from the standpoint of ensuring the accuracy of the analysis frequency difference dz, the time length of the analysis interval is set to, for example, 10 seconds or more, and more preferably, to 30 seconds or more. As can be understood from the foregoing explanation, the third embodiment has the benefit that the amount of processing of the acquisition module 11 is reduced by setting the analysis interval to a part of the time interval of the audio signal P, while maintaining a high level of accuracy of the specification of the analysis frequency difference dz.

### D: Fourth Embodiment

In the third embodiment, the position of the analysis interval on the time axis is set arbitrarily. Any of a plurality of aspects (D1-D4) illustrated below, for example, can be employed as the method for setting the position of the analysis interval on the time axis.

(1) Aspect D1

The acquisition module 11 in Aspect D1 analyzes the audio signal P in order to estimate structure sections of the musical piece. A structure sections is a section that divides a musical piece on the time axis in accordance with its musical significance or position within the musical piece. Examples of a structure section include an intro, an A-section (verse), a B-section (bridge), a chorus, and an outro. Any known music analysis technique (musical structure analysis) is employed for the estimation of the structure sections carried out by the acquisition module 11.

The acquisition module 11 sets an analysis interval within a specific structure section from among a plurality of structure sections of a musical piece. For example, there are cases in which there is no significant presence of the main musical sounds that constitute the musical piece (musical sounds that a user considers particularly important when playing a musical instrument) in the intro or outro of the musical piece. Based on this tendency, the acquisition module 11 sets an analysis interval of a prescribed length within a structure section of the audio signal P corresponding to the A-section, the B-section, or the verse.

The position of the analysis interval within the structure section is arbitrary. For example, the analysis interval can be set at a random position within the structure section, or be set so as to include a particular point within the structure section (for example, the starting point, the ending point, or the midpoint). The first spectrum St is generated by averaging the plurality of frequency spectra within the analysis interval set in accordance with the procedure described above.

(2) Aspect D2

The total number of performance sounds (hereinafter referred to as “number of sounds”) change over time within the musical piece represented by the audio signal P. The number of sounds means the total number of musical sounds with different pitches or tones, and is the total number of musical sounds that are generated in parallel with each other, or the total number of musical sounds that are generated within a unit time. It can be assumed that the analysis frequency difference dz can be specified with higher accuracy in a time interval of the audio signal P having a large number of sounds than with a time interval with a small number of sounds.

Based on this tendency, the acquisition module 11 of Aspect D2 sets, as the analysis interval, a time interval of the audio signal P having a large number of sounds. For example, the acquisition module 11 calculates the number of sounds for each of a plurality of time intervals obtained by dividing the audio signal P into prescribed time lengths, and selecting as the analysis interval the time interval with the maximum number of sounds from the plurality of time intervals. The first spectrum St is generated by averaging the plurality of frequency spectra within the analysis interval set in accordance with the procedure described above.

(3) Aspect D3

The acquisition module 11 of Aspect D3 sets as the analysis interval a time interval of the audio signal P that includes a performance sound of a specific musical instrument (hereinafter referred to as “specific musical instrument”). That is, the analysis interval is a time interval of the audio signal P that predominantly includes the tone of the performance sounds of a specific musical instrument. The specific musical instrument is, for example, a musical instrument selected by the user from among a plurality of candidates, a musical instrument having a high frequency or intensity of generation in the audio signal P, or a musical instrument with a long time length of sound generation in the audio signal P. For example, the acquisition module 11 determines the type of performance sound for each of a plurality of time intervals obtained by dividing the audio signal P into prescribed time lengths, and selecting the time interval from the plurality of time intervals. The first spectrum St is generated by averaging the plurality of frequency spectra within the analysis interval set in accordance with the procedure described above.

(4) Aspect D4

It can be assumed that the time interval of the musical piece represented by the audio signal P in which the analysis frequency difference dz should be specified (the time interval in the musical piece during which the user places emphasis on the analysis frequency difference dz) differs for each user. Therefore, the acquisition module 11 of Aspect D4 sets the position of the analysis interval on the time axis in accordance with instructions from the user. For example, the acquisition module 11 receives an instruction from the user to select any one of a plurality of time intervals obtained by dividing the audio signal P into prescribed time lengths and sets the time interval instructed by the user as the analysis interval.

### E: Fifth Embodiment

In the third embodiment, the analysis interval is set to a prescribed time length, but the time length of the analysis interval can be of variable length. Any of a plurality of aspects (E1-E2) illustrated below, for example, can be employed as the method for controlling the time length of the analysis interval.

(1) Aspect E1

The degree of dispersion (for example, the variance or difference) of the analysis frequency difference dy differs for each musical piece in accordance with the acoustic characteristics of the musical piece. It is necessary to ensure sufficient time for the analysis interval for musical pieces in which the degree of dispersion of the analysis frequency difference dy is large, but for musical pieces in which the degree of dispersion of the analysis frequency difference dy is small, it can be assumed that there tends to be the ability to specify the analysis frequency difference dx with high accuracy even if the analysis interval is short. Given the circumstances described above, the acquisition module 11 of Aspect E1 calculates the degree of dispersion of a plurality of analysis frequency differences dy respectively calculated for each of a plurality of time intervals of the audio signal P, and changes the time length of the analysis interval between cases in which the degree of dispersion exceeds a threshold value and cases in which the degree of dispersion falls below the threshold value. For example, if the degree of dispersion exceeds the threshold value, the acquisition module 11 sets the analysis interval to a first time length. On the other hand, if the degree of dispersion falls below the threshold value, the acquisition module 11 sets the analysis interval to a second time length that is shorter than the first time length. The acquisition module 11 calculates the first spectrum St for the analysis interval having the time length set by means of the procedure described above.

(2) Aspect E2

As can be ascertained from FIG. 12, the longer the time length of the analysis interval, the more accurately the analysis frequency difference dz can be specified. On the other hand, as the time length of the analysis interval decreases, the amount of processing required for specifying the analysis frequency difference dz also decreases. Moreover, it can be assumed that whether to prioritize accuracy of the analysis frequency difference dz or reduction in the processing amount will be different for each user. Therefore, the acquisition module 11 of Aspect E2 sets the time length of the analysis interval in accordance with instructions from the user. For example, if the user selects an operating mode that prioritizes accuracy of the analysis frequency difference dz, the acquisition module 11 sets the analysis interval to the first time length. On the other hand, if the user selects an operating mode that prioritizes reduction of the amount of processing, the acquisition module 11 sets the analysis interval to a second time length that is shorter than the first time length. The acquisition module 11 calculates the first spectrum St for the analysis interval having the time length set by means of the procedure described above.

### F: Sixth Embodiment

The frequency band in which the user places emphasis on the analysis frequency difference dz differs for each user. Thus, the acquisition module 11 can generate the first spectrum St for a specific frequency band (hereinafter referred to as “specific band”) on a frequency axis. For example, the acquisition module 11 calculates an average spectrum by averaging a plurality of frequency spectra in the analysis interval, and generates the first spectrum St by extracting components of a specific band of the average spectrum by means of a frequency domain filtering process. In another aspect, the acquisition module 11 extracts components of a specific band of the audio signal P by means of a time domain filtering process, and generates the first spectrum St by averaging a plurality of frequency spectra of the signal after extraction within the analysis interval.

The specific band can be a fixed frequency band that is set in advance or a variable frequency band in accordance with instructions from the user, for example. For example, the acquisition module 11 sets as the specific band a frequency band selected by the user from a plurality of frequency bands.

In addition, the specific band can be set in accordance with the performance of a musical instrument by the user. Specifically, the specific band is set in accordance with the musical sounds generated by a musical instrument by means of user performance. For example, the acquisition module 11 analyzes a sound collection signal generated by a sound collection device (microphone) by collecting the performance sound of a musical instrument, thereby specifying the frequency band to which the performance sound belongs. The acquisition module 11 sets the frequency band to which the performance sound belongs as the specific band. In another aspect, the acquisition module 11 identifies the type of musical instrument by analyzing the sound collection signal, and sets as the specific band the sound range registered for the musical instrument used by the user from a plurality of sound ranges registered for different musical instruments.

### G: Modified Examples

Specific modifications to be added to each of the foregoing aspects will be described below. Two or more modifications arbitrarily selected from the following examples can be appropriately combined as long as they are not mutually contradictory.

(1) In the third to fifth embodiments, the first spectrum St is acquired from an analysis interval which is a part of the audio signal P on the time axis, but the acquisition module 11 can acquire the first spectrum St using an interval on the time axis that includes components of a specific band of the audio signal P as the analysis interval. By means of the configuration described above, since the first spectrum St is acquired from an interval on the time axis that includes components of a specific frequency band of the audio signal P, for example, it is possible to acquire the first spectrum St from an interval on the time axis that includes components of a sound range of a specific musical instrument to thereby specify the analysis frequency difference dz with high accuracy while reducing the influence of noise, and the like.

(2) In the embodiments described above, a golden-section search is shown as an example of the problem-solving search algorithm, but the problem-solving search algorithm is not limited to the example described above. For example, a ternary search can be used as the problem-solving search algorithm. In a ternary search, “interval of unit area h1:interval of unit area h2:interval of unit area h3” is set to be “1:1:1” in FIG. 7. However, by means of a configuration for specifying the analysis frequency difference dy by using a golden-section search, it is possible to efficiently specify the analysis frequency difference dy as compared with a configuration for specifying the analysis frequency difference dy by using another problem-solving search algorithm, such as a ternary search.

(3) In the embodiments described above, the N reference values Rn are stored in the storage device 20, but it is possible to store only one reference value Rn (for example, 440 Hz). In the configuration described above, other reference values Rn are set at prescribed intervals from the one reference value Rn.

(4) In the embodiments described above, a reference value Rn defined by equal temperament is used as an example, but the reference value Rn can be defined by a temperament other than equal temperament. For example, the reference value Rn can be defined by a temperament of folk music, such as Indian music, or a temperament defined by arbitrary intervals on the frequency axis.

(5) In the first embodiment, if the analysis frequency difference dz falls below a prescribed threshold value, a sound corresponding to an audio signal P can be output without executing a process for adjusting the pitch of the audio signal P. For example, a frequency difference of less than 6 cent is difficult for the human ear to perceive. Therefore, for example, if the analysis frequency difference dz is less than 6 cent, a process for adjusting the pitch of the audio signal P is not executed.

(6) In the embodiments described above, the distance M is used as an index representing the degree of similarity between the first spectrum St and the provisional spectrum Sd, but an index representing the degree of similarity is not limited to the distance M. For example, the correlation between the first spectrum St and the provisional spectrum Sd can be used as an index representing the degree of similarity between the first spectrum St and the provisional spectrum Sd. The correlation increases as the first spectrum St and the provisional spectrum Sd become more similar. That is, the frequency difference dx of the provisional spectrum Sd whose correlation exceeds a threshold value is specified as the analysis frequency difference dy. As can be understood from the foregoing explanation, “the degree of similarity exceeds a threshold value” includes both “the distance M falls below the threshold value” and “the correlation exceeds the threshold value.”

(7) As described above, the functions of the audio signal analysis system 100 used as an example above are realized by means of cooperation between one or more processors that constitute the control device 10, and a program stored in the storage device 20. The program according to the present disclosure can be provided in a form stored in a computer-readable storage medium and installed on a computer. The storage medium is, for example, a non-transitory storage medium, a good example of which is an optical storage medium (optical disc) such as a CD-ROM, but can include storage media of any known format, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage device 20 that stores the program in the distribution device corresponds to the non-transitory storage medium.

### H: Additional Statement

For example, the following configurations can be understood from the embodiments exemplified above.

An audio signal analysis method according to one aspect (Aspect 1) of the present disclosure comprises acquiring a first spectrum which is a time average of a plurality of frequency spectra of an audio signal, acquiring a plurality of reference values corresponding to different pitches that follow a prescribed temperament, specifying, by means of a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and correcting the frequency difference so as to reduce systematic error included in the frequency difference specified by means of the problem-solving search algorithm. By means of the aspect described above, a frequency difference corresponding to a second spectrum which includes a plurality of components each having a frequency difference with respect a plurality of reference values corresponding to a pitch of a prescribed temperament, the second spectrum having a degree of similarity with the first spectrum exceeding a prescribed threshold value, is specified by means of the problem-solving search algorithm, and the frequency difference is corrected so as to reduce systematic error. Accordingly, it is possible to specify the analysis frequency difference more robustly and with higher accuracy while reducing the number of calculations, as compared with a conventional means (for example, the above-described comparative example).

In one example, (Aspect 2) of Aspect 1, the pitch of the audio signal is adjusted in accordance with the corrected frequency difference. By means of the aspect described above, since the pitch of the audio signal is adjusted in accordance with the corrected frequency difference, it is possible to tune a musical instrument in accordance with a reference value, so that the performance can be in accordance with the pitch of the audio signal.

In one example, (Aspect 3) of Aspects 1 or 2, the plurality of frequency spectra are a plurality of frequency spectra within an analysis interval, which is a part of the time interval of the audio signal, and when the first spectrum is acquired, the plurality of frequency spectra within the analysis interval are averaged, thereby generating the first spectrum. By means of the aspect described above, since the first spectrum is generated from the analysis interval corresponding to a part of the audio signal, the amount of processing required for generating the first spectrum is reduced, as compared with a configuration in which the entire time interval of the audio signal is used to generate the first spectrum.

In one example, (Aspect 4) of Aspect 3, the position of the analysis interval on the time axis is variable. By means of the aspect described above, it is possible to specify an appropriate analysis frequency difference from the analysis interval at a position corresponding to the characteristics of the audio signal or the intention of the user, for example.

In one example, (Aspect 5) of Aspects 3 or 4, the time length of the analysis interval is variable. By means of the aspect described above, it is possible to specify an appropriate analysis frequency difference from the analysis interval with a time length corresponding to the characteristics of the audio signal or the intention of the user, for example.

In one example, (Aspect 6) of any one of Aspects 1 to 5, when the first spectrum is acquired, a spectrum within a specific frequency band on a frequency axis is acquired as the first spectrum. By means of the aspect described above, the analysis frequency difference can be specified for only the acoustic components of a specific frequency band on the frequency axis.

In one example, (Aspect 7) of Aspect 1 or 2, the plurality of frequency spectra are a plurality of frequency spectra within an interval of the audio signal on the time axis including components of a specific frequency band, and when the first spectrum is acquired, the plurality of frequency spectra within the time interval that includes the components of the specific frequency band are averaged, thereby acquiring the first spectrum. By means of the above-described aspect, the first spectrum is acquired from an interval of the audio signal on a time axis including components of the specific frequency band. Therefore, for example, it is possible to acquire the first spectrum from an interval on the time axis that includes components of a sound range of a specific musical instrument, thereby specifying the frequency difference with high accuracy while reducing the influence of noise, and the like.

In one example, (Aspect 8) of any one of Aspects 1 to 7, the problem-solving search algorithm is a golden-section search. By means of the above-described aspect, since the frequency difference is specified by using the golden-section search, it is possible to specify the frequency difference more efficiently, as compared with a configuration for specifying the frequency difference by using another problem-solving search algorithm, such as a ternary search.

An audio signal analysis system according to one aspect (Aspect 9) of the present disclosure comprises an acquisition module for acquiring a first spectrum which is the time average of a plurality of frequency spectra of an audio signal, a specification module for acquiring a plurality of reference values corresponding to different pitches that follow a prescribed temperament, and specifying, by means of a problem-solving search algorithm, a frequency difference corresponding to a second spectrum which includes a plurality of components each having a frequency difference with respect to each of the plurality of reference values, the second spectrum being similar to the first spectrum with a degree of similarity that exceeds a prescribed threshold value, and a correction module for correcting the frequency difference so as to reduce systematic error included in the frequency difference specified by the specification module. By means of the aspect described above, a frequency difference corresponding to a second spectrum which includes a plurality of components each having a frequency difference with respect a plurality of reference values corresponding to a pitch of a prescribed temperament, the second spectrum having a degree of similarity with the first spectrum exceeding a prescribed threshold value, is specified by means of the problem-solving search algorithm, and the frequency difference is corrected so as to reduce systematic error. Therefore, it is possible to specify the analysis frequency difference more robustly and with higher accuracy while reducing the number of calculations, as compared with a conventional means (for example, the above-described comparative example).

In one example, (Aspect 10) of Aspect 9, a processing module that adjusts the pitch of the audio signal in accordance with the frequency difference after correction by the correction module is provided. By means of the aspect described above, since the pitch of the audio signal is adjusted in accordance with the corrected frequency difference, it is possible to tune a musical instrument in accordance with a reference value, so that the performance can be in accordance with the pitch of the audio signal.

In one example, (Aspect 11) of Aspects 9 or 10, the plurality of frequency spectra are a plurality of frequency spectra within an analysis interval which is part of the time interval of the audio signal, and the acquisition module averages the plurality of frequency spectra within the analysis interval, thereby generating the first spectrum. By means of the aspect described above, since the first spectrum is generated from the analysis interval corresponding to a part of the audio signal, the amount of processing required for generating the first spectrum is reduced, as compared with a configuration in which the entire time interval of the audio signal is used to generate the first spectrum.

In one example, (Aspect 12) of Aspect 11, the position of the analysis interval on the time axis is variable. By means of the aspect described above, it is possible to specify an appropriate analysis frequency difference from the analysis interval at a position corresponding to the characteristics of the audio signal or the intention of the user, for example.

In one example, (Aspect 13) of Aspects 11 or 12, the time length of the analysis interval is variable. By means of the aspect described above, it is possible to specify an appropriate analysis frequency difference from the analysis interval with a time length corresponding to the characteristics of the audio signal or the intention of the user, for example.

In one example, (Aspect 14) of any one of Aspects 9 to 13, the acquisition module acquires a spectrum within a specific frequency band on the frequency axis as the first spectrum. By means of the aspect described above, the analysis frequency difference can be specified only for the acoustic components of a specific frequency band on the frequency axis.

In one example, (Aspect 15) of Aspect 9 or 10, the plurality of frequency spectra are a plurality of spectra within an interval of the audio signal on the time axis that includes a specific frequency band, and the acquisition module averages the plurality of frequency spectra within the time interval including the components of the specific frequency band, thereby acquiring the first spectrum. By means of the aspect described above, since the first spectrum is acquired from an interval on the time axis that includes components of a specific frequency band of the audio signal, it is possible to acquire the first spectrum from an interval on the time axis that includes components of a sound range of a specific musical instrument, thereby specifying the frequency difference with high accuracy while reducing the influence of noise, and the like.

In one example, (Aspect 16) of any one of Aspects 9 to 15, the problem-solving search algorithm is a golden-section search. By means of the above-described aspect, since the frequency difference is specified by using the golden-section search, it is possible to specify the frequency difference more efficiently, as compared with a configuration for specifying the frequency difference by using another problem-solving search algorithm, such as a ternary search.

In one example, (Aspect 17) of Aspect 9 or 16, a display for displaying the frequency difference after correction by the correction module is provided. By means of the above-described aspect, since the corrected frequency difference is displayed on the display, the user can tune their own musical instrument in accordance with said frequency difference.

By means of a program according to one aspect (Aspect 18) of the present disclosure, a computer functions as an acquisition module for acquiring a first spectrum which is a time average of a plurality of frequency spectra of an audio signal, a specification module for acquiring a plurality of reference values corresponding to different pitches that follow a prescribed temperament, and for specifying, by means of a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and a correction module for correcting the frequency difference so as to reduce systematic error included in the frequency difference specified by the specification module.

What is claimed is:

1. An audio signal analysis method realized by a computer, the audio signal analysis method comprising:
acquiring a first spectrum, which is a time average of a plurality of frequency spectra of an audio signal;
acquiring a plurality of reference values corresponding to different pitches that follow a prescribed temperament;
specifying, by a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and
correcting the frequency difference so as to reduce systematic error included in the frequency difference specified by the problem-solving search algorithm.

2. The audio signal analysis method according to claim 1, further comprising
adjusting the pitch of the audio signal in accordance with the corrected frequency difference.

3. The audio signal analysis method according to claim 1, wherein
the plurality of frequency spectra are a plurality of frequency spectra within an analysis interval, which is a part of a time interval of the audio signal, and
the acquiring of the first spectrum includes averaging the plurality of frequency spectra within the analysis interval to generate the first spectrum.

4. The audio signal analysis method according to claim 3, wherein
a position of the analysis interval on a time axis is variable.

5. The audio signal analysis method according to claim 3, wherein
a time length of the analysis interval is variable.

6. The audio signal analysis method according to claim 1, wherein
the first spectrum is a spectrum within a specific frequency band on a frequency axis.

7. The audio signal analysis method according to claim 1, wherein
the plurality of frequency spectra are a plurality of frequency spectra within an interval of the audio signal on a time axis that includes components of a specific frequency band, and
the acquiring of the first spectrum includes averaging the plurality of frequency spectra within the interval that includes the components of the specific frequency band to acquire the first spectrum.

8. The audio signal analysis method according to claim 1, wherein
the problem-solving search algorithm is a golden-section search.

9. An audio signal analysis system, comprising
an electronic controller including at least one processor, the electronic controller being configured to execute a plurality of modules including
an acquisition module configured to acquire a first spectrum, which is a time average of a plurality of frequency spectra of an audio signal,
a specification module configured to acquire a plurality of reference values corresponding to different pitches that follow a prescribed temperament and configured to specify, by a problem-solving search algorithm, a frequency difference corresponding to a second spectrum which includes a plurality of components each having a frequency difference with respect to each of the plurality of reference values, the second spectrum being similar to the first spectrum with a degree of similarity exceeding a prescribed threshold value, and
a correction module configured to correct the frequency difference so as to reduce systematic error included in the frequency difference specified by the specification module.

10. The audio signal analysis system according to claim 9, wherein
the electronic controller is configured to further execute a processing module that is configured to adjust the pitch of the audio signal in accordance with the frequency difference after correction by the correction module.

11. The audio signal analysis system according to claim 9, wherein
the plurality of frequency spectra are a plurality of frequency spectra within an analysis interval, which is a part of a time interval of the audio signal, and
the acquisition module is configured to average the plurality of frequency spectra within the analysis interval to generate the first spectrum.

12. The audio signal analysis system according to claim 11, wherein
a position of the analysis interval on a time axis is variable.

13. The audio signal analysis system according to claim 11, wherein
a time length of the analysis interval is variable.

14. The audio signal analysis system according to claim 9, wherein
the first spectrum is a spectrum within a specific frequency band on a frequency axis.

15. The audio signal analysis system according to claim 9, wherein
the plurality of frequency spectra are a plurality of spectra within an interval of the audio signal on a time axis that includes components of a specific frequency band, and
the acquisition module is configured to average the plurality of frequency spectra within the time interval that includes the components of the specific frequency band to acquire the first spectrum.

16. The audio signal analysis system according to claim 9, wherein
the problem-solving search algorithm is a golden-section search.

17. The audio signal analysis system according to claim 9, further comprising
a display configured to display the frequency difference after correction by the correction module.

18. A non-transitory computer-readable medium storing a program that causes a computer to function as:
an acquisition module that is configured to acquire a first spectrum, which is a time average of a plurality of frequency spectra of an audio signal;
a specification module configured to acquire a plurality of reference values corresponding to different pitches that follow a prescribed temperament and configured to specify, by a problem-solving search algorithm, a frequency difference corresponding to a second spectrum which includes a plurality of components each having a frequency difference with respect to each of the plurality of reference values, the second spectrum being similar to the first spectrum with a degree of similarity that exceeds a prescribed threshold value, and
a correction module configured to correct the frequency difference so as to reduce systematic error included in the frequency difference specified by the specification module.
